(19) United States
(12) Patent Application Publication
(10) Pub. No.: US 2017/0076232 A1
(43) Pub. Date: Mar. 16, 2017

(54) MANAGING FREIGHT TRANSPORTATION

(71) Applicant: Tranztec Solutions, Inc, Perrysburg, OH (US)

(72) Inventor: Toby W. Miller, Perrysburg, OH (US)

(21) Appl. No.: 15/262,898

(22) Filed: Sep. 12, 2016

Related U.S. Application Data
(60) Provisional application No. 62/217,454, filed on Sep. 11, 2015.

(51) Int. Cl. G06Q 10/06; G06F 3/0482; G06Q 10/08

(52) U.S. Cl. CPC G06Q 10/0633; G06Q 10/0833; G06F 3/0482; G06Q 50/30

(57) ABSTRACT

Managing freight transportation includes adding a graphical card to a graphical list, where the graphical card is linked to a freight order and the graphical list is linked to a freight transportation data. The graphical list is assigned to a graphical board with the graphical board being linked to a freight transportation category, the freight order linked in the graphical card is transported in view of the freight transportation data. Multiple graphical cards, graphical lists, and graphical boards can be employed, where more than one graphical card can be added to any given graphical list, with each graphical card linked to a different freight order and each instance of a graphical card modifiable and updatable throughout. Transporting the freight order can include shipping a container including the freight order using one or more vehicles, including motor vehicles, railed vehicles, watercraft, and aircraft.

### CROSS-REFERENCE TO RELATED APPLICATIONS

This application claims the benefit of U.S. Provisional Application No. 62/217,454, filed on Sep. 11, 2015. The entire disclosure of the above application is incorporated herein by reference.

### FIELD

The present technology relates to systems and methods for managing freight transportation and electronically representing aspects of freight transportation, and in particular relates to systems and methods for planning, managing, tracking, optimizing, and visualizing freight transportation and related objects.

### INTRODUCTION

This section provides background information related to the present disclosure which is not necessarily prior art.

Freight transportation is an extremely complicated business that involves coordination of freight, schedules, equipment, drivers, routes, regulations, and much more. Software to ease the burden of managing these complex relationships and requirements exists and has made freight transportation one of the most technologically advanced industries today. Such software, however, has grown more complex and the industry has largely forgotten its history and the visual nature of its operation. Gone are the days when one could, at a glance, see exactly where drivers are located, where the drivers need to be, and how a transportation fleet is performing. Today those important details are clouded by endless grids, data entry forms, and reports. Such systems are disconnected from each other, do not allow sharing or collaboration between users, and display information in difficult to understand grids and data entry forms.

### SUMMARY

The present technology includes ways to electronically represent aspects of freight transportation and includes systems and methods for managing freight transportation, including planning, tracking, optimizing, and visualizing freight transportation and related objects.

Systems and methods of managing freight transportation are provided that include adding a graphical card to a graphical list, where the graphical card is linked to a freight order and the graphical list is linked to a freight transportation data. The graphical list is assigned to a graphical board, where the graphical board is linked to a freight transportation category. The freight order is transported in view of the freight transportation data. The freight order can include a pickup location and a delivery location. The freight transportation data can include a transportation route, transportation status, a vehicle operator, a vehicle identity, a vehicle type, a container type, and/or a container identity. The freight transportation category can be defined by a dispatcher, a carrier, a receiver, a shipping means, a container type, and/or a location or region. The systems and methods can employ a plurality of graphical cards, a plurality of graphical lists, and a plurality of graphical boards, where adding the graphical card to the graphical list includes adding more than one graphical card to at least one graphical list, each added graphical card linked to a different freight order.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates organization of graphical cards including freight transportation data into graphical lists and grouping graphical cards of like type into a defined graphical board.

FIG. 2 illustrates data synchronization between a relational database of freight transportation data and a real-time database that updates upon a change of freight transportation data, including a change related to a graphical card, graphical list, and/or graphical board, where the updates can be accessed over a web-based network.

FIG. 3 illustrates freight transportation information display over a web-based network of the updated real-time database, where the display can be selected to display certain freight transportation information, including graphical card(s), graphical lists(s), and graphical board(s) by type or keyword, including additional information and non-card attachments, such as geo-spatial location or map position, and where the display can be integrated and/or synchronized with other applications.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. Except where otherwise expressly indicated, all numerical quantities in this description are to be understood as modified by the word “about” and all geometric and spatial descriptors are to be understood as modified by the word “substantially” in describing the broadest scope of the technology.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

The present technology provides systems and methods for managing freight transportation that include electronically representing aspects of freight transportation, including the planning, tracking, optimizing, and/or visualizing of freight transportation and various related objects. The present systems and methods organize and link various freight transportation related data, including objects such as vehicle operators, vehicles, trailers or shipping containers, orders, and invoices, via one or more electronic interfaces, such as a web page accessed using a web browser. In particular, the transportation related data includes objects represented in the form of a graphical card. The term “graphical,” as used herein, identifies a representation made using electronic or computer-based graphics.

Prior to electronic displays, freight transportation dispatchers used physical cards to represent various objects or resources in a freight transportation system and moved the cards from one physical board to another physical board to provide a highly visual means of tracking where various objects or resources were at-a-glance. These physical cards could be manually coupled together to form relationships between cards of various types (e.g., drivers to trucks, trucks to trailers, etc.) and would make it easy to simultaneously move a coupled set of resources. These physical cards, coupled cards, and boards have been replaced in certain instances by electronic systems and software. Certain electronic freight transportation systems, however, fail to provide the simplicity of the prior card and board systems, including the simple but effective representation of linked resources and location thereof. The present technology improves the ability of freight transportation companies to quickly and easily visualize and manage their freight without having to sort through grids or deal with complicated computer databases.

In some embodiments, the present technology can work with existing freight transportation software and provides a platform to visualize planning, tracing, and management freight transportation. The present technology can include a web based freight planning and tracking system. Graphical cards representing freight, drivers, equipment, and routes can be organized into user defined graphical boards. Using a process template system, the graphical cards can be grouped into logical graphical lists that can be based on status, route, customer, or any other user defined groups.

In various embodiments, the present technology simplifies data from various data grids and reports by providing electronic visualization features that give an at-a-glance view of various freight transportation aspects. A user can define as many graphical boards as needed and can move graphical cards easily from one board to another using an electronic interface. Each graphical card can show up-to-date information about the freight and provide current details such as stops, estimated time of arrival, routing, and more. The graphical cards can be easily dragged and dropped from one graphical list to another indicating status, route assignment, or other similar grouping. Load cards can be tagged with user-defined color coded labels for rapid identification. Assignments (e.g., operator, vehicle, container, etc.) can be pinned to the top of each graphical card so that what is covered and what is not covered is readily identified. Cards can display images that are attached or linked thereto, and can display routing and transit details. Routing details can be updated automatically as graphical cards are moved and changed and provide details such as transit time, mileage, and other information including hours of service details and more. Details are displayed in real-time without the need to hit a refresh button as cards are automatically and rapidly updated as information is changed.

In certain embodiments, the present technology includes integration capabilities that allow it to work hand in hand with existing electronic and software based freight transportation systems. Graphical boards within the present technology can subscribe to information from external dispatch systems and load boards so that freight is automatically added to the appropriate graphical board and graphical list as such are created. Information that is updated is automatically sent to the appropriate integrated application providing seamless real-time integration with existing systems. The present technology can be integrated with various third-party web services, applications, or communication systems. The present technology can also be integrated various communications platforms for full service track and trace for brokerage and logistics companies.

In some embodiments, the present technology can be configured to invite other entities to collaborate on any of the user defined graphical boards. The user can control the access and security to one or more graphical boards. In this way, a user employing the present systems and methods can collaborate with other dispatchers, departments, divisions, or even external personnel. Every action taken with respect to a particular graphical card and/or graphical board can be audited and identified in the graphical card and/or graphical board details. Public graphical boards can be employed to take collaboration to expand collaboration beyond the user and the company, thereby including customers, intermediaries, and other freight carriers. The present technology allows a user to therefore engage with other members of the user's company or one or more collaborators, and can include making a public graphical board allowing the user to share loads with other entities. For example, a load represented by a graphical card that needs covered can be moved by the user to a public graphical board and one or more other companies can collaborate with the user on covering the freight. These other companies can either update the load directly using the present technology or can choose to receive the load via EDI or email, for example. Shipment status updates and e-mail correspondence can be automatically placed back on the particular load's card so the user's entire organization is instantly updated with the latest information.

In various embodiments, the present technology provides an interface, such as a web interface, for planning and tracking freight transportation. The interface can allow creation of potential freight transportation loads for advanced planning and what-if scenarios. Loads can be quickly added to one or more boards with minimal data entry by dragging and dropping or cutting and pasting data to create various cards and/or coupling various cards to link data. Loads can also be automatically created from an email or other message or request sent to the graphical board. Potential loads for planning purposes can be automatically sent over a dispatch system only when (and if) they become real. In this way, various freight transport scenarios can be developed and can even include modification and input from other entities using one or more shared or public graphical boards. These aspects can be implemented without the complex training and deployment often associated with other dispatch systems and software.

In certain embodiments, systems and methods of managing freight transportation can include the display of freight transportation related data objects, such as one or more vehicle operators, vehicles, trailers or shipping containers, orders, invoices, etc., via one or more electronic interfaces, such as a web page accessed using a web browser. Displaying the freight transportation related data objects can include displaying one or more graphical cards. Cards of like type (e.g., vehicle operators) can be grouped into a defined graphical list(s) and/or graphical board(s).

In some embodiments, one or more graphical cards can be grouped into one or more graphical lists and/or graphical boards. Each graphical board can be linked to a freight transportation category, where such categories include freight orders for a particular dispatcher, freight orders for a particular shipper, freight orders for a particular carrier, freight orders for a particular receiver, freight orders for a particular shipping means, freight orders for a particular container type, freight orders for a particular location or region, freight orders for a particular user/

Attorney dispatcher, freight orders to be transported by one or more carriers, etc. Each graphical board can be defined as either public or private. Private graphical boards can only be accessed by other users who have been invited to that board. Public graphical boards can be accessed by any users within the system. Cards can be further grouped into user-defined graphical lists within a particular board. Cards can also be moved from one list to another by dragging and dropping a card on top of another list. Cards within a board can be labeled or tagged with values that are unique to a particular board to allow for quick location and reference.

In various embodiments, one or more graphical lists can be defined by a process template that can define the purpose of the list within a given graphical board, such that moving a graphical card from one graphical list to another graphical list within the graphical board automatically causes the defined process to be executed. One or more workflow processes can be automatically triggered when a graphical card is moved from one graphical list to another graphical list as defined by the selected process template for a given graphical board. The process template allows for data to automatically be updated, created, or managed based on the movement of a graphical card from one graphical list to another graphical list, such as changing the status or state of a given graphical card based on the containing graphical list, or changing the collective geographical routing of a given graphical list based on a graphical card being added or removed from that graphical list.

In certain embodiments, one or more graphical cards can be manually entered by the user directly into one or more graphical boards, or one or more graphical cards can be completed by subscribing to data in an external system that automatically creates graphical cards based on a pre-defined set of criteria. Such subscriptions can execute a pre-defined synchronization workflow process to extract data from external systems, databases, or web services that meet pre-defined criteria for creation of a graphical card. Cards may have data automatically added to their details by extracting the data from one or more external systems, databases, or web services. Such external systems, databases, and/or web services can include a real-time or NoSQL database, such as MongoDB, or Raven that can provide high speed storage for the freight transportation data objects defined by the graphical cards within a graphical board.

In some embodiments, one or more graphical cards from one graphical board of a single given type can be attached to one or more graphical cards on another graphical board of a different given type. More than one graphical card from a graphical board of a single given type can be attached to a single graphical card on another graphical board of a different given type. The single graphical card and its associated graphical cards can be dragged and dropped from one graphical list to another graphical list within a given graphical board, where attached graphical cards follow that dragging operation and act as one graphical card. A defined set of criteria or rules that define which graphical card types can be attached to which other graphical card types can be employed to control, guide, and structure certain graphical card movements.

In various embodiments, non-card attachments can be included or added to a given graphical card, where such non-card attachments include data like documents, images, binary objects, or other digital material. These non-card attachments can be displayed in thumbnail form on the front of the graphical card to which they are attached and can be enlarged upon selection thereof. Each graphical card defined within the system can include a geo-spatial location or position composed of latitude and longitude, or other coordinate system that indicates a location on a map or a geographically based reference. The geo-spatial location, position, or map displaying such can be provide as a non-card attachment. One or more graphical cards can be displayed and a particular graphical card's relation and proximity to other related or unrelated graphical cards can be displayed on a map or other digital geographically based reference medium. Each graphical card can be expanded to provide additional data details related thereto by being selected using a cursor, pen, finger, or other pointing device on various types of displays, including a touch screen display.

In certain embodiments, systems and methods of managing freight transportation include adding a graphical card to a graphical list, the graphical card linked to a freight order and the graphical list linked to a freight transportation data. The graphical list is assigned to a graphical board, the graphical board linked to a freight transportation category. The freight order is transported in view of the freight transportation data. The freight order can include a pickup location and a delivery location, while the freight transportation data can include one or more of a transportation route, transportation status, a vehicle operator, a vehicle identity, a vehicle type, a container type, and a container identity. The freight transportation category can be defined by one or more of a dispatcher, a carrier, a receiver, a shipping means, a container type, and a location or region.

In some embodiments, systems and methods employ a graphical board that is private and accessible by a selected user. Another selected user can be invited to access the private graphical board. In other embodiments, the systems and methods can employ a graphical board that is public and accessible to more than one user.

In various embodiments, systems and methods further include adding another graphical card to the graphical list, where the another graphical card is linked to another freight order. For example, the adding step can include adding a plurality of graphical cards to a plurality of graphical lists. The graphical card can also be assigned to another graphical list, where the another graphical board is linked to another freight transportation category. Adding the graphical card to the graphical list can include dragging and dropping the graphical card onto the graphical list. The graphical card can also be marked with an identifying mark, such as a color, a label, and/or a graphic. Systems and methods can further include adding the graphical card to another graphical list. In this way, the graphical card can be present in multiple lists and can be present in multiple boards. The present systems and methods and can further include modifying the graphical card, where the graphical card is present in more than one graphical list, and where modifying the graphical card updates the graphical card in the more than one graphical list. In this way, multiple representations of the graphical card can be automatically updated in every associated location—i.e., every graphical list and/or graphical board including an instance of the card is updated. The graphical card can also be linked to another graphical card. Movement of the graphical card between graphical lists or graphical boards can then include movement of the another graphical card linked thereto.

As described, each graphical card can be linked to a particular freight order. Each graphical card can include or be linked to additional information, where the particular freight order identity and the additional information can follow the graphical card wherever the graphical card is added, moved, or copied, including instances of the graphical card in more than one graphical list and/or more than one graphical board. Changes made to one instance of the graphical card in the system or method can change all instances of the graphical card, where the display of the changes can be accomplished by real-time updates. The graphical card can be linked to other graphical cards, thereby creating a relationship between the linked graphical cards.

The graphical card(s), the graphical list(s), and/or the graphical board(s) can the relationships therebetween can be displayed in various ways. For example, the graphical board can display one or more graphical lists contained therein and each graphical list can display one or more graphical cards contained therein. These graphical cards, lists, and boards can be zoomed at differing levels (boards contain lists or cards, lists contain other lists or cards, and cards can be related to other cards. The graphical list can include other graphical lists, resulting in a multidimensional graphical list, for example. The graphical list can automatically react to an addition or removal of contents thereof, including the addition or removal of one or more graphical cards or the addition or removal of one or more other graphical lists. Examples of such automatic reaction include creating calculations, summarizing data (averages, sums, etc), triggering events (turning off/on machines, tracking the physical vehicle, etc.), altering visualization, etc. Display or format of the graphical card can be changed, including maximizing and minimizing display thereof. The graphical card can also be represented in different ways while still representing the same card (e.g., mini-card (front/back), full card (front/back), clipped cards (i.e. several cards clipped together), etc.).

Systems and methods can include a plurality of graphical cards, a plurality of graphical lists, and a plurality of graphical boards, where each graphical card can be assigned to at least one graphical list and/or assigned to at least one graphical board, where each graphical card can be marked with an identifying mark linked to the assigned graphical list or board. Where the systems and methods include a plurality of graphical cards, a plurality of graphical lists, and a plurality of graphical boards, addition of the graphical card to the graphical list can include adding more than one graphical card to at least one graphical list, where each added graphical card linked to a different freight order.

In certain embodiments, the graphical list can include a process template and adding the graphical card to the graphical list can result in the graphical card being placed in a group by the process template according to a parameter selected from the freight transportation data. For example, the added graphical card can be placed in a group by the process template with another graphical card in the graphical list according to a parameter selected from the freight transportation data. Systems and methods can further include removing one of the graphical card and the another graphical card from the graphical list, wherein the process template can then update the group based on the remainder of the graphical card and the another graphical card.

In some embodiments, adding the graphical card to the graphical list can include creating the graphical card using preexisting data accessed from a database. Adding the graphical card to the graphical list can also include creating the graphical card following receipt of a freight order. Systems and methods can further include synchronizing the graphical card, the graphical list, and the graphical board with a remote display or a remote database including the graphical card, the graphical list, and the graphical board following the adding and assigning steps. In this way, multiple dispatchers or users can observe updated graphical cards, graphical lists, and graphical boards, including where the synchronization occurs in real-time to provide real-time updates amongst users.

In various embodiments, systems and methods can further include appending additional information to the graphical card. The additional information can include various types of information, such as a geo-spatial location, a position, an electronic document, an image, and/or a map. The appending can include linking the additional information to the graphical card or can include attaching the additional information to the graphical card. Where the system or method includes a plurality of graphical cards, a plurality of graphical lists, and a plurality of graphical boards, the freight order includes a pickup location and a delivery location, and the freight transportation data includes a transportation route, the system or method can display at least one of the pickup location, the delivery location, and the transportation route on a map for each graphical card in a respective graphical list.

In certain embodiments, transporting the freight order includes shipping a container including the freight order using a vehicle. The vehicle can be a motor vehicle, a railed vehicle, a watercraft, or an aircraft. Multiple vehicles and types of vehicles can be employed depending on the transportation route.

In some embodiments, the present technology can be configured for integration with other freight transport systems and software. Examples of other systems and software include various Transportation Management Systems (TMS) such as TMW Suite, TruckMate, TL2000 (iSeries), McLeod, Innovative (iSeries), and MercuryGate, among others.

Particular embodiments of the present technology include the systems and methods for electronically representing aspects of freight transportation available from Tranztec Solutions, Inc. (Perrysburg, Ohio) identified by the VIA® trademark.

### EXAMPLES

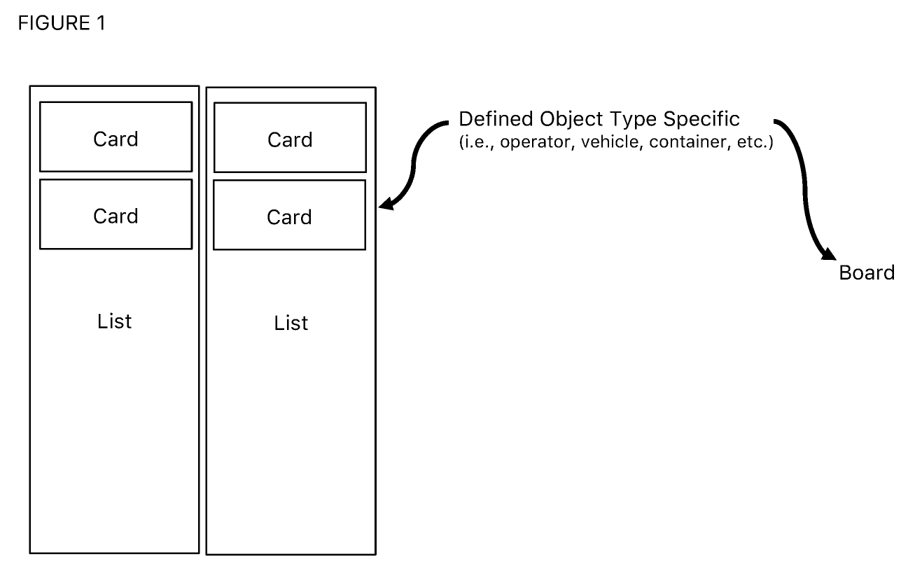

Referring now to FIGS. 1, 2, and 3, aspects of certain embodiments of the present technology are represented in either graphical or flowchart format.

FIG. 1 provides a graphical display of graphical cards including freight transportation data into graphical lists, where the graphical lists containing the graphical cards are assigned to a graphical board. Two graphical lists are shown, each including two graphical cards. However, the graphical board can include any number of graphical lists, where each graphical list can include any number of graphical cards. Each graphical list can further include one or more other graphical lists, these other graphical lists each including other graphical cards, making multidimensional lists, for example. It is further noted that one graphical card on each list shown can be the same graphical card, where addition, removal, or modification of the graphical card results in updating the other graphical card.

In this manner, each instance of the graphical card can be automatically updated, which can further include the any additional documents, annotations, images, etc. appended to any instance of the graphical card. The display of the graphical lists including the graphical cards provides a clear depiction and organization means for managing freight transportation of various freight orders versus a tabular, grid, or spreadsheet format of freight orders.

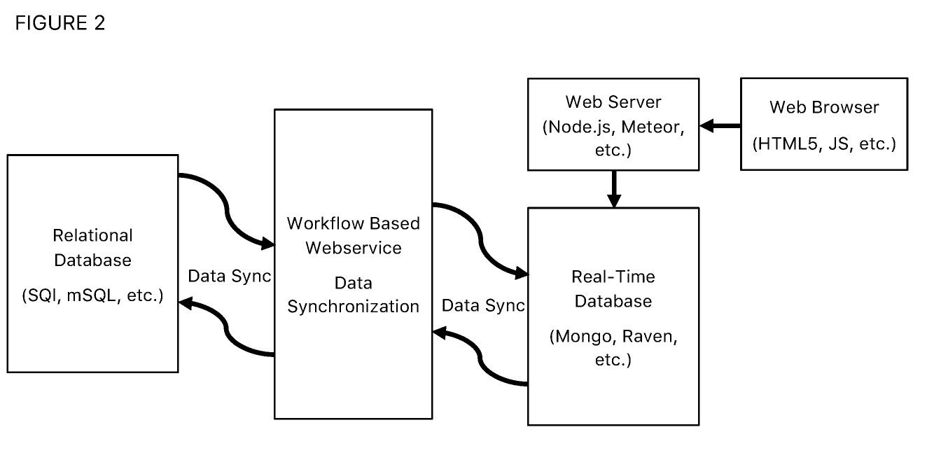

FIG. 2 illustrates data synchronization between a relational database of freight transportation data and a real-time database that updates upon a change of freight transportation data, including a change related to a graphical card, graphical list, and/or graphical board, where the updates can be accessed over a web-based network. In this manner, one or more users or dispatchers can access and employ the present systems and methods to modify multidimensional graphical lists including various graphical cards, where any changes are made and populated in real-time amongst every instance of the changed graphical card throughout the several graphical lists and graphical boards.

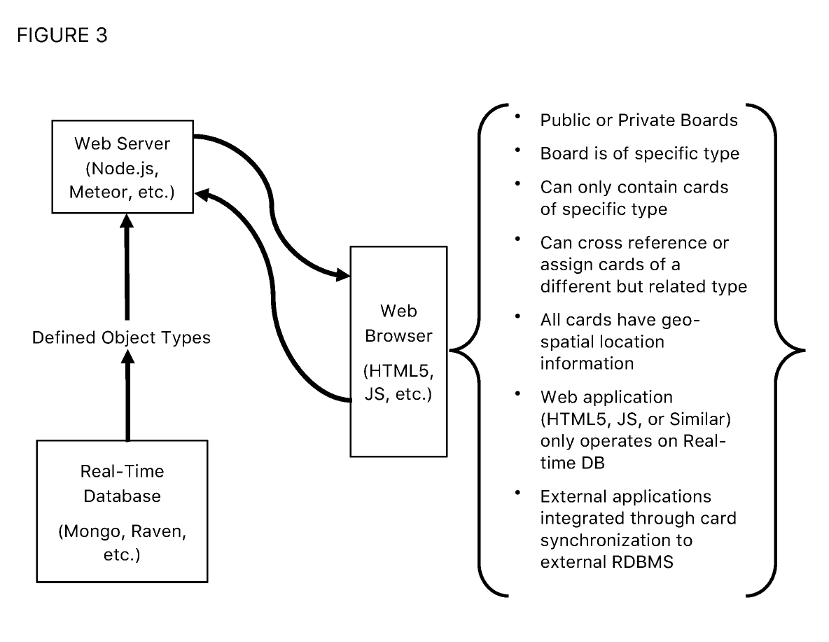

FIG. 3 illustrates the display of freight transportation information over a web-based network of an updatable real-time database, where the display can be selected for certain freight transportation information, including graphical cards, graphical lists, and graphical boards by type or keyword, including additional information and non-card attachments, such as geo-spatial location or map position, and where the display can be integrated and/or synchronized with other applications. This allows a user to sort freight orders based on selected freight transportation data, readily update and view any changes in each instance thereof, and display the status of the freight transportation system and method so that the respective freight order(s) can be transported in view of the updated freight transportation data.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of managing freight transportation comprising:
adding a graphical card to a graphical list, the graphical card linked to a freight order and the graphical list linked to a freight transportation data, the graphical list assigned to a graphical board, and the graphical board linked to a freight transportation category; and
transporting the freight order in view of the freight transportation data.

2. The method of claim 1, wherein the freight order includes a pickup location and a delivery location.

3. The method of claim 1, wherein the freight transportation data includes a member selected from the group consisting of a transportation route, transportation status, a vehicle operator, a vehicle identity, a vehicle type, a container type, a container identity, and combinations thereof.

4. The method of claim 1, wherein the freight transportation category is defined by a member selected from the group consisting of a dispatcher, a carrier, a receiver, a shipping means, a container type, a location or region, and combinations thereof

5. The method of claim 1, wherein the graphical board is private and accessible by a selected user.

6. The method of claim 5, further comprising inviting another selected user to access the private graphical board.

7. The method of claim 1, wherein the graphical board is public and accessible to more than one user.

8. The method of claim 1, further comprising adding another graphical card to the graphical list, the another graphical card linked to another freight order.

9. The method of claim 1, wherein the adding step includes adding a plurality of graphical cards to a plurality of graphical lists.

10. The method of claim 1, further comprising assigning the graphical list to another graphical board, the another graphical board linked to another freight transportation category.

11. The method of claim 1, wherein adding the graphical card to the graphical list includes dragging and dropping the graphical card onto the graphical list.

12. The method of claim 1, further comprising adding the graphical card to another graphical list.

13. The method of claim 1, further comprising modifying the graphical card, wherein the graphical card is present in more than one graphical list, and modifying the graphical card updates the graphical card in the more than one graphical list.

14. The method of claim 1, further comprising linking the graphical card to another graphical card.

15. The method of claim 1, further comprising marking the graphical card with an identifying mark.

16. The method of claim 15, wherein the identifying mark includes a member selected from the group consisting of a color, a label, a graphic, and combinations thereof

17. The method of claim 1, further comprising a plurality of graphical cards, a plurality of graphical lists, and a plurality of graphical boards, wherein each graphical card is assigned to at least one graphical board and each graphical card is marked with an identifying mark linked to the assigned graphical board.

18. The method of claim 1, further comprising a plurality of graphical cards, a plurality of graphical lists, and a plurality of graphical boards, wherein adding the graphical card to the graphical list includes adding more than one graphical card to at least one graphical list, each added graphical card linked to a different freight order.

19. The method of claim 1, wherein the graphical list includes a process template and adding the graphical card to the graphical list results in the graphical card being placed in a group by the process template according to a parameter selected from the freight transportation data.

20. The method of claim 19, wherein the added graphical card is placed in a group by the process template with another graphical card in the graphical list according to a parameter selected from the freight transportation data.

21. The method of claim 20, further comprising removing one of the graphical card and the another graphical card from the graphical list, wherein the process template updates the group based on the remainder of the graphical card and the another graphical card.

22. The method of claim 1, wherein adding the graphical card to the graphical list includes creating the graphical card using preexisting data accessed from a database.

23. The method of claim 1, wherein adding the graphical card to the graphical list includes creating the graphical card following receipt of a freight order.

24. The method of claim 1, further comprising synchronizing the graphical card, the graphical list, and the graphical board with a remote display or a remote database including the graphical card, the graphical list, and the graphical board following the adding and assigning steps.

25. The method of claim 1, further comprising appending additional information to the graphical card.

26. The method of claim 25, wherein the additional information includes a member selected from the group consisting of a geo-spatial location, a position, an electronic document, an image, a map, and combinations thereof.

27. The method of claim 25, wherein the appending includes one of linking the additional information to the graphical card and attaching the additional information to the graphical card.

28. The method of claim 1, further comprising a plurality of graphical cards, a plurality of graphical lists, and a plurality of graphical boards, wherein the freight order includes a pickup location and a delivery location, wherein the freight transportation data includes a member selected from the group consisting of a transportation route, wherein at least one of the pickup location, the delivery location, and the transportation route is displayed on a map for each graphical card in a respective graphical list.

29. The method of claim 1, wherein transporting the freight order includes shipping a container including the freight order using a vehicle.

30. The method of claim 29, wherein the vehicle is a member selected from the group consisting of a motor vehicle, a railed vehicle, a watercraft, and an aircraft.
